(19) United States
(12) Patent Application Publication
(10) Pub. No.: US 2016/0214287 A1
(43) Pub. Date: Jul. 28, 2016

(54) COMPOSITION FOR FORMING A COMPONENT STRUCTURE AND METHOD OF MAKING AND USING THE SAME

(71) Applicant: GM Global Technology Operations LLC, Detroit, MI (US)

(72) Inventors: CHARLES K. BUEHLER, LANSING, MI (US); DAVID A. OKONSKI, LAKE ORION, MI (US); CHRIS OBERLITNER, SHELBY TOWNSHIP, MI (US)

(21) Appl. No.: 14/607,457

(22) Filed: Jan. 28, 2015

(51) Int. Cl. B29C 45/00; B29C 35/02; C08K 3/34; B29C 45/40

(52) U.S. Cl. CPC B29C 45/0025; B29C 45/4005; B29C 35/02; B29C 45/0013; C08K 3/34; B29K 2101/12

(57) ABSTRACT

A number of variations may include a product comprising: component structure having at least one surface and at least one protrusion, wherein the component structure comprises a thermoplastic polymer material and a filler, and wherein the surface and protrusion are constructed and arranged such that the component structure is substantially free of sink.

### TECHNICAL FIELD

The field to which the disclosure generally relates to includes component structures.

### BACKGROUND

Component structures, which may include polymer materials, may exhibit defects such as, but not limited to, sink marks when produced.

### SUMMARY OF ILLUSTRATIVE VARIATIONS

A number of variations may include a product having a component structure having at least one surface and at least one protrusion, wherein the component structure comprises a thermoplastic polymer material and a filler, and wherein the surface and protrusion are constructed and arranged such that the component structure is substantially free of sink. A number of variations may include a method including providing a mold comprising a first mold portion, a second mold portion, and a part injector; positioning the first mold portion and second mold portion to form a mold cavity; positioning the part ejector into the mold cavity that it defines at least a portion of the mold cavity; introducing a first molten polymer material into a mold cavity; curing said first molten polymer material to form a first component structure having at least one surface and at least one protrusion, wherein the component structure comprises a thermoplastic polymer material and a filler, and wherein the surface and protrusion are constructed and arranged such that the component structure is substantially free of sink.; and removing the first component structure from the mold.

Other illustrative variations within the scope of the invention will become apparent from the detailed description provided hereinafter. It should be understood that the detailed description and specific examples, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a component structure according to a number of variations.

FIG. 2 illustrates a component structure and method of making a component structure according to a number of variations.

FIG. 3 illustrates a component structure and method of making a component structure according to a number of variations.

FIG. 4 illustrates a component structure and method of making a component structure according to a number of variations.

### DETAILED DESCRIPTION OF ILLUSTRATIVE VARIATIONS

The following description of the variations is merely illustrative in nature and is in no way intended to limit the invention, its application, or uses.

As used throughout the specification, the phrases “about” and “at or about” are intended to mean that the amount or value in question may be the value designated or some other value about the same. The phrase is intended to convey that similar values promote equivalent results or effects according to the invention.

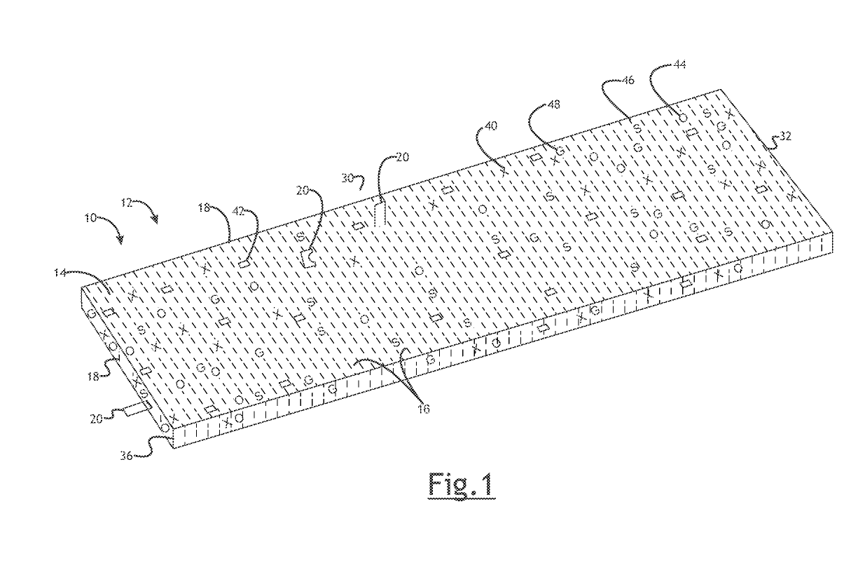

FIG. 1 illustrates a number of variations. In a number of variations, a product 10 is shown. In a number of variations, the product 10 may include a component structure 12. In a number of variations, the component structure 12 may include a polymer material (12) in liquid or solid form. In a number of variations, the component structure 12 may include a thermoplastic polymer material 14 and a filler 16. In a number of variations, the component structure 12 may have at least one surface 18. In a number of variations, the component structure 12 may have a plurality of surfaces 18. In a number of variations, the component structure 12 may have at least one protrusion 20 along one of its surfaces 18. In a number of variations, the component structure 12 may have a coefficient of linear expansion of about 5×10⁻⁵ mm/(mm·° C.) or less. In a number of variations, the component structure 12 may have a melt flow rate of greater than about 30 grams/10 min. In a number of variations, the product 10 or component structure 12 may be a component in a number of industries including, but not limited to, transportation (e.g., ground, air, marine, rail, or space), computer, electronic, housewares, appliance, construction, or architectural industries. In a number of variations, the product 10 or component structure 12 may be a component for a vehicle. In a number of variations, the product 10 or component structure 12 may form a class “A” automotive part of a vehicle. In a number of variations, the product 10 or component structure 12 may include any color (including, but not limited to, blue, red, yellow, green, orange, purple, pink, brown, grey, black, white, shades thereof, patterns thereof, combinations thereof, or may be another type) or design and/or shape to fit the product 10 or component structure's 12 desired application. In a number of variations, the product 10 or component structure 12 may be constructed and arranged to be substantially free of sink. In a number of variations, the product 10 or component structure 12 may be constructed and arranged to be substantially free of sink on at least one of its surfaces 18 and/or protrusions 20. In a number of variations, the component structure 12 may have a length 30, a width or diameter 32, and a thickness or wall stock 36 defined by the surfaces 18 of the component structure 12. In a number of variations, the sink may take the form of sink marks, which may be imperfections on the surface 18 that may take on the form of dimples, craters or ripples formed during formation of a solid component structure 12. In a number of variations the sink may require formation of a second attachment piece because the sink causes a disconnect in desired and actual location between attachment protrusions of the component structure 12 and its potential attachment piece depending on the component structure's 12 application. In a number of variations, sink may lead to poor quality of the component structure 12 or polymer material. In a number of variations, the component structure 12 may eliminate the need of providing a second attachment piece, may eliminate the need for post mold tooling, welding and/or taping, and may provide a mass savings depending on the application of the component structure 12.

In a number of variations, the component structure 12 and/or thermoplastic polymer material 14 may comprise a thermoplastic polyolefin (TPO). In a number of variations, the TPO may be present from about 70 to 100 weight percent of a solid form of the component structure 12. In a number of variations, the component structure 12 and/or thermoplastic polymer material 14 may comprise a polymer including, but not limited to, Acrylonitrile butadiene styrene (ABS), Acrylic (PMMA), Celluloid, Cellulose acetate, Cycloolefin Copolymer (COC), Ethylene-Vinyl Acetate (EVA), Ethylene vinyl alcohol (EVOH), Fluoroplastics (including PTFE, FEP, PFA, CTFE, ECTFE, ETFE) Ionomers, Kydex™, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyetheretherketone (PEEK), Polyetherketoneketone (PEKK), Polyetherimide (PEI), Polyethersulfone (PES), Polysulfone, Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC), Styrene-acrylonitrile (SAN), polycarbonate+acrylonitrile butadiene styrene mix (ABS+PC), Polypropylene (PP) (including, but not limited to, impact, random, and homo), Polyethylene (PE) (including, but not limited to, linear low density, linear high density), combinations or blends in any amount thereof, or may be another type. In a number of variations, the component structure 12 and/or thermoplastic polymer material 14 may be a homopolymer, copolymer, terpolymer, or may be another type. In a number of variations, the component structure 12 and/or thermoplastic polymer material 14 may be a combination of polymers in any amount or concentration. In a number of variations, the component structure 12 and/or thermoplastic polymer material 14 may have a broad melting point ranging from about 90 to about 170° C. In a number of variations, the component structure 12 and/or thermoplastic polymer material 14 may have a broad melting point ranging from about 90 to about 350° C. In a number of variations, the component structure 12 and/or thermoplastic polymer material 14 may have multiple melting zones. In a number of variations, the component structure 12 and/or thermoplastic polymer material 14 may have a melt flow rate (MFR) of greater than about 12 grams/10 min.

In a number of variations, the component structure 12 may include a filler 16. In a number of variations, the filler 16 may be present in about 0 to about 30 weight percent of the solid component structure 12. In a number of variations, the filler 16 may be calcium carbonate, carbon fibers, talc, mica, woliastonite, calcinated clay, kaolin, magnesium sulfate, magnesium silicate, barium sulphate, titanium dioxide, sodium aluminum carbonate, barium ferrite, and potassium titanate, graphite, diatomaceous earth, silica, glass, carbon, carbide particles, ceramic particles, rubber, nitride, nitrile, phenolic, zeolite, aramid, montmorillinite clays, magnesium oxide whiskers, combinations thereof, or may be another type. In a number of variations, the filler 16 may take the form of particles. In a number of variations, the filler 16 particles may range in diameter from about 1 to about 150 μm. In a number of variations, the filler 16 particles may range in diameter from about 50 to about 500 μm. In a number of variations, the 3D filler 16 particles may be spherical, oblong, cubical, polyhedral, elliptic, oval, cocoon, whisker, rectangular, irregularly shaped, combinations thereof, or may be another type. In a number of variations, the filler 16 particles may be uniformly distributed or aggregated throughout the component structure 12. In a number of variations, the filler 16 may comprise at least about 0 to about 30% of the component structure 12 by weight. In a number of variations, the component structure 12 and/or thermoplastic polymer material 14 may have a coefficient of linear expansion of less than about 5×10⁻⁵ mm/(mm·° C.).

In a number of variations, the component structure 12 may further comprise one or more heat stabilizers 40. The one or more heat stabilizers 40 may include copper salts and/or derivatives thereof. In a number of variations, the heat stabilizers 40 may include copper halides or copper acetates; divalent manganese salts and/or derivatives thereof and mixtures thereof. In a number of variations, copper salts may be used in combination with halide compounds and/or phosphorus compounds, and may be used in combination with iodide or bromide compounds, and may be used in combination with potassium iodide or potassium bromide. In a number of variations, when present, the one or more heat stabilizers 40 may be present in an amount from at or about 0.1 to at or about 3 wt-%, or from at or about 0.1 to at or about 1 wt-%, or from at or about 0.1 to at or about 0.7 wt-%, the weight percentage being based on the weight of the component structure 12.

In a number of variations, the component structure 12 may further comprise one or more antioxidants 42 such as phosphate or phosphonite stabilizers, hindered phenol stabilizers, hindered amine stabilizers, aromatic amine stabilizers, thioesters, and phenolic based antioxidants. In a number of variations, when present, the one or more antioxidants 42 may comprise from at or about 0.1 to at or about 3 wt-%, or may comprise from at or about 0.1 to at or about 1 wt-%, or may comprise from at or about 0.1 to at or about 0.7 wt- %, the weight percentage being based on the weight of the resin composition.

In a number of variations, the component structure 12 may further comprise one or more impact modifiers 44. In a number of variations, the impact modifiers 44 may include polyamide ionomers, carboxyl-functionalized polyolefins, plastomers, co-polymer TPEs, TPVEs, natural rubbers and/or mixtures or combinations thereof.

In a number of variations, the component structure 12 may further comprise ultraviolet light stabilizers 46 such as, but not limited to, hindered amine light stabilizers (HALS), carbon black, substituted resorcinols, salicylates, benzotriazoles, and benzophenones. In a number of variations, the component structure 12 may further comprise general modifiers 48 such as, but not limited to, flow enhancing additives, lubricants, antistatic agents, coloring agents, pigments, flame retardants, nucleating agents, crystallization promoting agents and other processing aids known in the polymer compounding art.

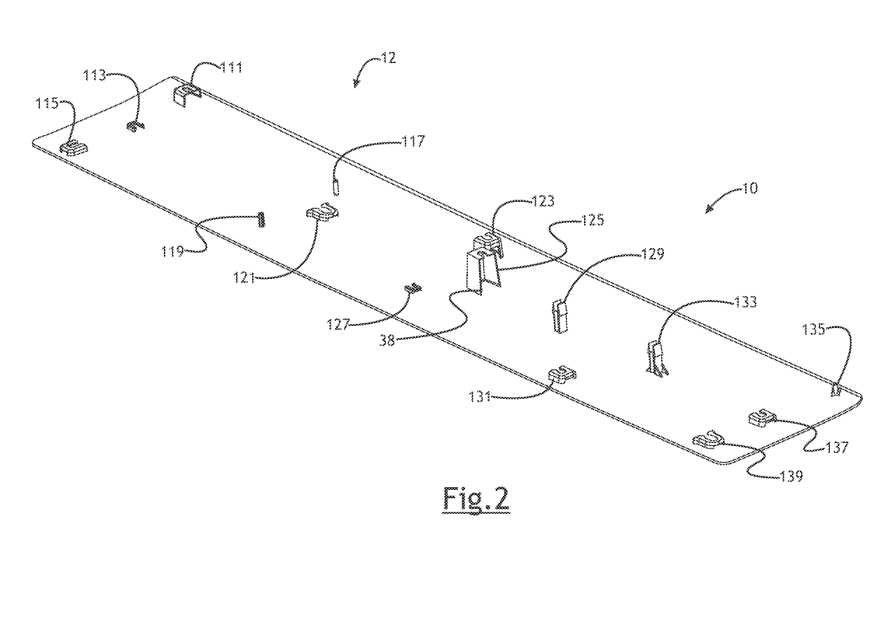

As shown in FIG. 2, in a number of variations, the component structure 12 may have a protrusion 20 along one of its surfaces 18. In a number of variations, the protrusion 20 may serve as an attachment to a different component depending on the component structure 12 application. In a number of variations, the protrusion 20 may be a standard dog house 111 (>6 to 40 mm in height), micro-dog house 113 (2 to 4 mm in height), small dog house 115 (>4 to <6 mm in height), round locator boss 117, star locator boss 119, “S” shaped small dog house contained with parting line 121, standard dog house 123 (>6 to 40 mm in height), standard dog house 125 (>6 to 40 mm in height), micro dog house 127 (2 to 4 mm in height, different location for flow pattern), carrot 129, small dog house 131 (>4 to <6 mm in height, lifter crossing parting line), carrot with gussets 133, clip attachment boss for accepting a screw 135, small dog house with lifter contained within parting line 137, “S” shaped dog house with flow pattern and parting line cross 139, and elastic averaging-type features, other protrusions or attachments known in the polymer compounding art, or may be another type. In a number of variations, the protrusion 20 may have a thickness or wall stock 38. In a number of variations, the wall stock 38 of the protrusion 20 may be about 15 to about 30% of the wall stock 36 of the component structure 12.

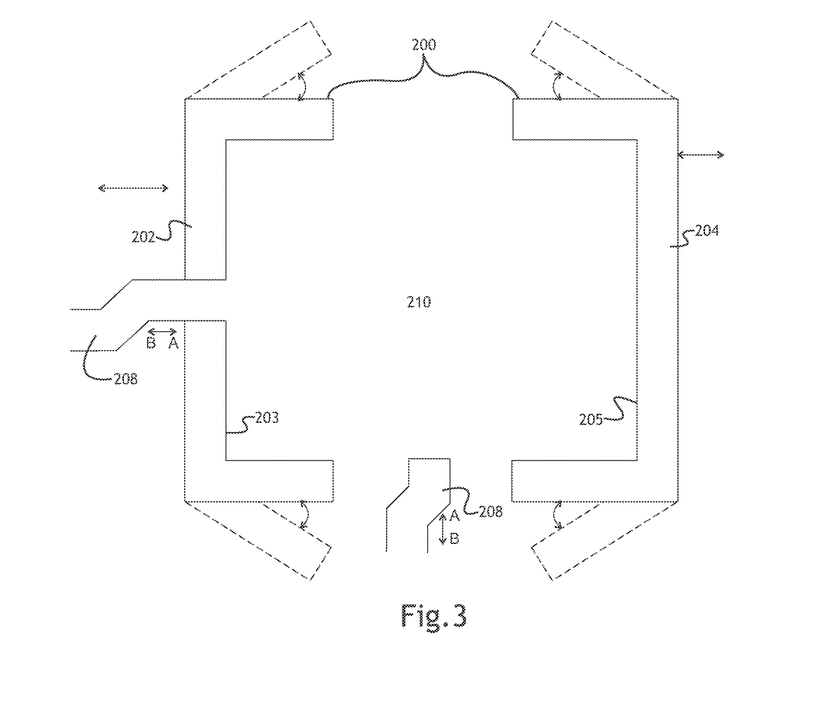

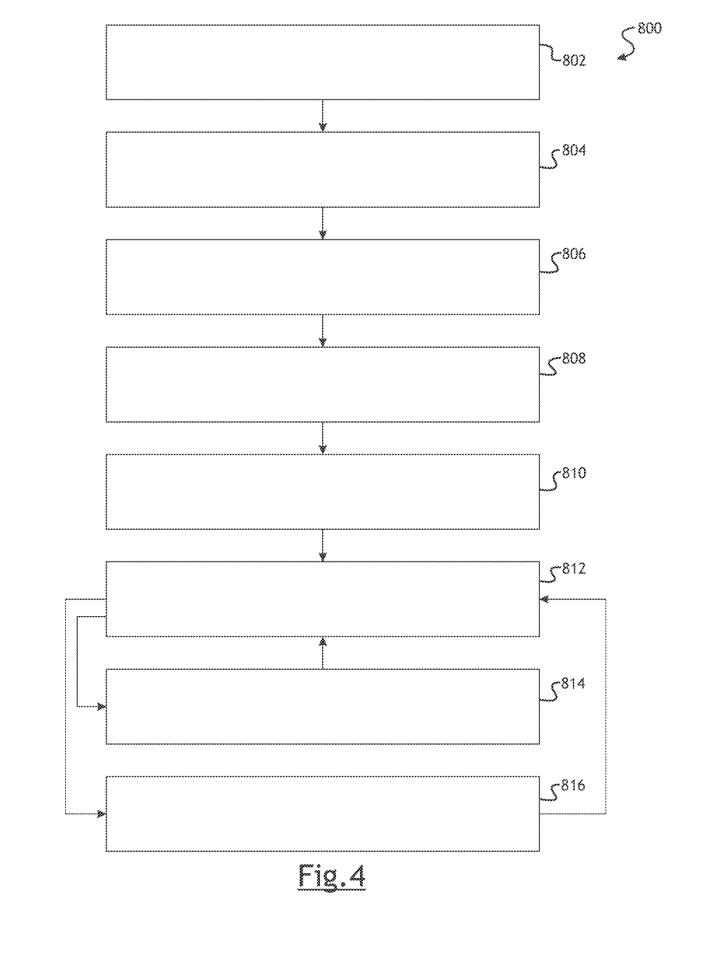

With references to FIG. 3-4, in a number of variations, a method 800 is shown. In a number of variations, in step 802, the method may include providing a mold 200. In a number of variations, the mold 200 may include a first mold portion 202 and a second mold portion 204. In a number of variations, the first mold portion 202 and/or the second mold portion 204 may have at least one reversibly positionable part injector 208 located therein. In a number of variations, the part injector 208 may be located separately from the separate first and second mold portions 202, 204. In a number of variations, the first mold portion 202 and/or the second mold portion 204 may have an interior surface 203, 205 respectively. In a number of variations, the interior surfaces 203, 205 of the first and second mold portions 202, 204 may be variably moved depending on the desired application shape of the finished component structure 12. In a number of variations, in step 804, the first mold portion interior surface 203 and the second mold portion interior surface 205 may be positioned to form a mold cavity 210 defined by the interior surfaces 203, 205 of the first mold portion 202 and second mold portion 204 when they may be joined, combined, abutted, or form a union. In a number of variations, the mold cavity 210 may be any shape depending on the application of the component structure 12. In a number of variations, the mold cavity 210 (and the molded protrusion formed therein) may be substantially tubular having a cross sectional shape selected from circular shapes, oval shapes (e.g., elliptical shapes), polygonal shapes (e.g., triangular, rectangular—including squares, pentagonal, hexagonal, heptagonal, octagonal, etc.), irregular shapes, and combinations thereof. In a number of variations, the mold cavity 210 (and the molded protrusion formed therein) may be elongated, for example in the form of an elongated slot or channel.

In a number of variations, the part injector 208 may reside within the first mold portion 202, the second mold portion 204, or both. In a number of variations, the part injector 208 may help form the mold cavity 210. In a number of variations, the part injector 208 may be moved manually or mechanically between first and second part injector positions A and B (and vice versa). In a number of variations, the part injector 208 may be moved mechanically, for example hydraulically by means of a drive-arm (not shown).

In a number of variations, the first mold portion 202 and second mold portion 204 may be reversibly positionable relative to each other. One of first mold portion 202 or second mold portion 204 may be moveable, while the other may be stationary. In a number of variations, the first and second mold portions may be reversibly positioned by known methods, for example, manually or mechanically. In a number of variations, the mold portions may be reversibly positioned by mechanical means, for example, by hydraulically driven drive-arms (not shown) along rails or tubular guides (not shown), in accordance with art-recognized methods.

In a number of variations, in step 806, the part injector 208 may be positioned in first part ejector position A, such that the part injector 208 may be positioned into the mold cavity 210 such that it defines at least a portion of the mold cavity 210. In a number of variations, in step 808, a first molten polymer material 12 may then be introduced into mold cavity 210. In a number of variations, the first molten polymer material 12 may be introduced into the mold cavity 210 at a temperature ranging from about 15 to 180° C. and a pressure ranging from about 2,000 to 18,000 psi. In a number of variations, in step 810, after introduction of the molten polymer material 12 into the mold cavity 210, the first molten polymer material 12 may be allowed to at least partially solidify or cure, thus forming a first component structure 12 having at least one surface and at least one protrusion, and wherein the component structure comprises a thermoplastic polymer material and a filler. In a number of variations, suitable curing agents may include anything that accelerates cooling such as, but not limited to, nucleating agents including, but not limited to, benzoic acid, kaolin, or sodium benzoate. In a number of variations, the dimensions of the mold cavity 210 may form the surfaces 18 of the solid component structure 12. In a number of variations, the component structure 12 may include the surface and protrusion are constructed and arranged such that the component structure is substantially free of sink. In a number of variations, in step 812, the first mold portion 202 and/or the second mold portion 204 may be retracted for removal of the solid component structure 12 from the mold 200 for use in its desired application. In a number of variations, the part injector 208 may be retracted or moved to position B where it may be withdrawn from the mold cavity 210. In a number of variations, the part injector may move to position B along with either the first mold portion 202 or second mold portion 204 in unison. In a number of variations, the presence of sink may be determined by visual inspection of at least one surface 18 of the component structure 12. In a number of variations, the first mold portion 202 and second mold portion 204 may compress by clamping during or after at least partial formation of the solid component structure 12. In a number of variations, the clamp force between the first mold portion 202 and second mold portion 204 during formation of the first solid component structure 12 may ranges from about 2.5 tons/in² to about 6 tons/in².

In a number of variations, optionally in step 814, a second molten polymer material 12a may be introduced into the mold cavity 210 and allowed to at least partially solidify or cure to form a compounded component structure 12b. In a number of variations, optionally in step 816, a plurality of additional molten polymer materials 12c may be introduced into the mold cavity 210 and allowed to at least partially solidify or cure to form a compounded component structure 12d. In a number of variations, the first component structure 12 may be allowed to substantially completely solidify prior to introduction of the second molten polymer material 12a and/or plurality of additional molten polymer materials 12c. In a number of variations, the mold cavity 210 may be constructed to allow for the first component structure 12 prior to introduction of the second molten polymer material 12a and/or plurality of additional molten polymer materials 12c. In a number of variations, the second and/or plurality of additional molten polymer materials 12a, 12c may have the same concentrations and materials as the first component structure 12. In a number of variations, the second and/or plurality of additional molten polymer materials 12a, 12c may have different concentrations and materials as the first component structure 12.

In a number of variations, the at least one protrusion 20 may be formed as part of the mold cavity 210 upon introduction of the first molten polymer material 12. In a number of variations, the at least one protrusion 20 may be formed as part of the mold cavity 210 upon introduction of the second molten solid polymer material 12a and/or plurality of additional molten polymer materials 12c.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include product comprising a component structure having at least one surface and at least one protrusion, wherein the component structure comprises a thermoplastic polymer material and a filler, and wherein the surface and protrusion are constructed and arranged such that the component structure is substantially free of sink.

Variation 2 may include a product as set forth in Variation 1 wherein the thermoplastic polymer material comprises at least one of TPO, PP, PE, ABS, ABS+PC, Nylon, PBT, or PEEK.

Variation 3 may include a product as set forth in any of Variations 1-2 wherein the filler comprises talc.

Variation 4 may include a product as set forth in any of Variations 1-3 wherein the thermoplastic polymer material is a homopolymer, copolymer, or terpolymer.

Variation 5 may include a product as set forth in Variation 4 wherein the protrusion comprises at least one of a dog house, locator boss, carrot, or clip attachment.

Variation 6 may include a product as set forth in any of Variations 1-5 wherein component structure has a coefficient of linear expansion of about 5×10⁻⁵ mm/(mm·° C.) or less.

Variation 7 may include a product as set forth in any of Variations 1-6 wherein the component structure has a melt flow rate of greater than about 12 grams/10 min.

Variation 8 may include a product as set forth in Variations 1-7 wherein the component structure comprises a protrusion wall stock that is about 15 to about 30% of a component structure wall stock.

Variation 9 may include a product as set forth in any of Variations 1-8 wherein the filler is at least 12% of the total weight of the component structure.

Variation 10 may include a product as set forth in any of Variations 1-9 wherein the component structure is a component for a vehicle.

Variation 11 may include a method including providing a mold comprising a first mold portion, a second mold portion, and a part injector; positioning the first mold portion and second mold portion to form a mold cavity; positioning the part ejector into the mold cavity that it defines at least a portion of the mold cavity; introducing a first molten polymer material into a mold cavity; curing said first molten polymer material to form a first component structure having at least one surface and at least one protrusion, wherein the component structure comprises a thermoplastic polymer material and a filler, and wherein the surface and protrusion are constructed and arranged such that the component structure is substantially free of sink; and removing the first component structure from the mold.

Variation 12 may include a method as set forth in Variation 11 wherein the curing is done with a clamp force between the first mold portion and the second mold portion in a range between about 2.6 tons/in² and about 6 tons/in².

Variation 13 may include a method as set forth in any of Variations 11-12 wherein the thermoplastic polymer material comprises at least one of TPO, PP, PE, ABS, ABS+PC, Nylon, PBT, or PEEK.

Variation 14 may include a method as set forth in any of Variations 11-13 wherein the filler comprises talc.

Variation 15 may include a method as set forth in any of Variations 11-14 wherein the thermoplastic polymer material is a homopolymer, copolymer, or terpolymer.

Variation 16 may include a method as set forth in any of Variations 11-15 wherein the protrusion comprises at least one of dog house, locator boss, carrot, or clip attachment.

Variation 17 may include a method as set forth in any of Variations 11-16 wherein component structure has a coefficient of linear expansion of about 5×10⁻⁵ mm/(mm·° C.) or less.

Variation 18 may include a method as set forth in any of Variations 11-17 wherein the component structure has a melt flow rate of greater than about 12 grams/10 min.

Variation 19 may include a method as set forth in any of Variations 17-18 wherein the component structure comprises a protrusion wall stock is about 15 to 30% of a component structure wall stock.

Variation 20 may include a method as set forth in any of Variations 17-19 wherein the filler is at least 12% of the total weight of the component structure.

Variation 21 may include a method, and/or a product as set forth in any of Variations 1-20 component structure is a class “A” automotive part of a vehicle.

Variation 22 may include a method, and/or a product as set forth in any of Variations 1-21 wherein the component structure is a color from a group comprising blue, red, yellow, green, orange, purple, pink, brown, grey, black, white, shades thereof, or combinations thereof.

Variation 23 may include a method, and/or a product as set forth in any of Variations 1-22 wherein the thermoplastic polymer material comprises at least one of Acrylonitrile butadiene styrene (ABS), Acrylic (PMMA), Celluloid, Cellulose acetate, Cycloolefin Copolymer (COC), Ethylene-Vinyl Acetate (EVA), Ethylene vinyl alcohol (EVOH), Fluoroplastics (including PTFE, FEP, PFA, CTFE, ECTFE, ETFE) Ionomers, Kydex™, a trademarked acrylic/PVC alloy, Liquid Crystal Polymer (LCP)Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyetheretherketone (PEEK), Polyetherketoneketone (PEKK), Polyetherimide (PEI), Polyethersulfone (PES), Polysulfone, Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC), Styrene-acrylonitrile (SAN), polycarbonate+acrylonitrile butadiene styrene mix (ABS+PC), Polypropylene (PP) (including, but not limited to, impact, random, and homo), Polyethylene (PE) (including, but not limited to, linear low density, linear high density) or combinations or blends in any amount thereof.

Variation 24 may include a method, and/or a product as set forth in any of Variations 1-23 wherein the component structure and/or thermoplastic polymer material may be a homopolymer, copolymer, terpolymer, or may be another type.

Variation 25 may include a method, and/or a product as set forth in any of Variations 1-24 wherein the component structure and/or thermoplastic polymer material have broad melting points ranging from about 90° C. to about 350° C.

Variation 26 may include a method, and/or a product as set forth in any of Variations 1-25 wherein the filler takes the form of particles.

Variation 26 may include a method, and/or a product as set forth in any of Variations 1-25 wherein the filler comprises at least one of calcium carbonate, carbon fibers, talc, mica, woliastonite, calcinated clay, kaolin, magnesium sulfate, magnesium silicate, barium sulphate, titanium dioxide, sodium aluminum carbonate, barium ferrite, and potassium titanate, graphite, diatomaceous earth, silica, glass, carbon, carbide particles, ceramic particles, cashew oil, rubber, nitride, nitrile, phenolic, zeolite, aramid, or montmorillinite clays, magnesium oxide whiskers, or combinations thereof.

Variation 27 may include a method, and/or a product as set forth in any of Variations 1-26 wherein the filler particles range in diameter from about 50 to about 150 μm.

Variation 28 may include a method, and/or a product as set forth in any of Variations 1-27 wherein the filler particles range in diameter from about 50 to about 500 μm.

Variation 29 may include a method, and/or a product as set forth in any of Variations 1-28 wherein the 3D filler particles comprise a shape comprising at least one of spherical, oblong, cubical, polyhedral, elliptic, oval, cocoon, rectangular, irregularly shaped, or combinations thereof.

Variation 30 may include a method, and/or a product as set forth in any of Variations 1-29 wherein the filler particles are aggregated throughout the component structure.

Variation 31 may include a method, and/or a product as set forth in any of Variations 1-30 wherein the filler comprises at least about 20 to about 30% of the component structure by weight.

Variation 32 may include a method, and/or a product as set forth in any of Variations 1-31 wherein the component structure and/or thermoplastic polymer material has multiple melting zones.

Variation 33 may include a method, and/or a product as set forth in any of Variations 1-32 wherein the component structure comprise one or more heat stabilizers comprising at least one of copper halides, copper acetates; divalent manganese salts and/or derivatives thereof and mixtures thereof copper salts in combination with halide compounds and/or phosphorus compounds, copper salts in combination with iodide or bromide compounds, or copper salts in combination with potassium iodide or potassium bromide.

Variation 34 may include a method, and/or a product as set forth in any of Variations 1-33 wherein the heat stabilizers are present in an amount from at or about 0.1 to at or about 3 wt-%, or from at or about 0.1 to at or about 1 wt-%, or from at or about 0.1 to at or about 0.7 wt-% of the component structure.

Variation 35 may include a method, and/or a product as set forth in any of Variations 1-34 wherein the component structure comprise one or more antioxidants comprising at least one of phosphate or phosphonite stabilizers, hindered phenol stabilizers, hindered amine stabilizers, aromatic amine stabilizers, thioesters, or phenolic based antioxidants.

Variation 36 may include a method, and/or a product as set forth in any of Variations 1-35 wherein antioxidants are present in an amount from at or about 0.1 to at or about 3 wt-%, or may comprise from at or about 0.1 to at or about 1 wt-%, or may comprise from at or about 0.1 to at or about 0.7 wt-% of the component structure.

Variation 37 may include a method, and/or a product as set forth in any of Variations 1-36 wherein the component structure comprises one or more impact modifiers comprising at least one of polyamide ionomers, carboxyl-functionalized polyolefins, or mixtures thereof.

Variation 38 may include a method, and/or a product as set forth in any of Variations 1-37 wherein the component structure comprises one or more ultraviolet light stabilizers comprising at least one of hindered amine light stabilizers (HALS), carbon black, substituted resorcinols, salicylates, benzotriazoles, orbenzophenones.

Variation 39 may include a method, and/or a product as set forth in any of Variations 1-38 wherein the component structure comprises general modifiers comprising at least one of flow enhancing additives, lubricants, antistatic agents, coloring agents, pigments, flame retardants, nucleating agents, or crystallization promoting agents.

Variation 40 may include a method, and/or a product as set forth in any of Variations 1-39 wherein the protrusion serves as an attachment to a different component depending on the composite structure application.

Variation 41 may include a method, and/or a product as set forth in any of Variations 1-40 wherein the protrusion comprises at least one of standard dog house (>6 to 40 mm in height), micro-dog house (2 to 4 mm in height), small dog house (>4 to <6 mm in height), round locator boss, star locator boss, “S” shaped small dog house contained with parting line, standard dog house (>6 to 40 mm in height), standard dog house (>6 to 40 mm in height), micro dog house (about 2 mm in height, different location for flow pattern), carrot, small dog house (>4 to <6 mm in height, lifter crossing parting line), carrot with gussets, clip attachment boss for accepting a screw, small dog house with lifter contained within parting line, “S” shaped dog house with flow pattern and parting line cross, or elastic averaging-type features.

Variation 42 may include a method, and/or a product as set forth in any of Variations 1-41 wherein the part injector is located separately from the separate first and second mold portions.

Variation 43 may include a method, and/or a product as set forth in any of Variations 1-42 wherein the first mold portion and/or the second mold portion has at least one reversibly positionable part injector located therein.

Variation 44 may include a method, and/or a product as set forth in any of Variations 1-43 wherein the mold cavity is a shape comprising at least one of substantially tubular having a cross sectional shape selected from circular shapes, oval shapes (e.g., elliptical shapes), polygonal shapes (e.g., triangular, rectangular—including squares, pentagonal, hexagonal, heptagonal, octagonal, etc.), irregular shapes, or combinations thereof.

Variation 45 may include a method, and/or a product as set forth in any of Variations 1-44 wherein at least one of the first mold portion, second mold portion, or injector is moved mechanically by a hydraulically driven drive arms.

Variation 46 may include a method, and/or a product as set forth in any of Variations 1-45 wherein the first molten polymer material is introduced into the mold cavity 210 at a temperature of 15 to 180° C. and a pressure of between 2,000 to 18,000 psi.

Variation 47 may include a method, and/or a product as set forth in any of Variations 1-46 wherein a second molten polymer material is introduced into the mold cavity and allowed to at least partially solidify or cure to form a compounded component structure.

Variation 48 may include a method, and/or a product as set forth in any of Variations 1-47 wherein a plurality of additional molten polymer materials are introduced into the mold cavity and allowed to at least partially solidify or cure to form a compounded component structure.

Variation 49 may include a method, and/or a product as set forth in any of Variations 1-48 wherein the at least one protrusion is formed as part of the mold cavity upon introduction of the first molten polymer material.

Variation 50 may include a method, and/or a product as set forth in any of Variations 1-49 wherein the at least one protrusion is formed as part of the mold cavity upon introduction of the second molten solid polymer material and/or plurality of additional molten polymer materials.

The above description of select examples of the invention is merely exemplary in nature and, thus, variations or variants thereof are not to be regarded as a departure from the spirit and scope of the invention.

What is claimed is:

1. A product comprising:
a component structure having at least one surface and at least one protrusion, wherein the component structure comprises a thermoplastic polymer material and a filler, and wherein the surface and protrusion are constructed and arranged such that the component structure is substantially free of sink.

2. A product as set forth in claim 1 wherein the thermoplastic polymer material comprises at least one of TPO, PP, PE, ABS, ABS+PC, Nylon, PBT, or PEEK.

3. A product as set forth in claim 1 wherein the filler comprises talc.

4. A product as set forth in claim 1 wherein the thermoplastic polymer material is a homopolymer, copolymer, or terpolymer.

5. A product as set forth in claim 1 wherein the protrusion comprises at least one of a dog house, locator boss, carrot, or clip attachment.

6. A product as set forth in claim 1 wherein component structure has a coefficient of linear expansion of about 5×10⁻⁵ mm/(mm·° C.) or less.

7. A product as set forth in claim 1 wherein the component structure as a melt flow rate of greater than about 12 grams/10 min.

8. A product as set forth in claim 1 wherein the component structure comprises a protrusion wall stock that is about 15 to about 30% of a component structure wall stock.

9. A product as set forth in claim 1 wherein the filler is at least 12% of the total weight of the component structure.

10. A product as set forth in claim 1 wherein the component structure is a component for a vehicle.

11. A method comprising
providing a mold comprising a first mold portion, a second mold portion, and a part injector;
positioning the first mold portion and second mold portion to form a mold cavity;
positioning the part ejector into the mold cavity that it defines at least a portion of the mold cavity;
introducing a first molten polymer material into a mold cavity;
curing said first molten polymer material to form a first component structure having at least one surface and at least one protrusion, wherein the component structure comprises a thermoplastic polymer material and a filler, and wherein the surface and protrusion are constructed and arranged such that the component structure is substantially free of sink; and
removing the first component structure from the mold.

12. A method as set forth in claim 11 wherein curing is done with a clamp force between the first mold portion and the second mold portion in a range between about 2.6 tons/in² and about 6 tons/in².

13. A method as set forth in claim 11 wherein the thermoplastic polymer material comprises at least one of TPO, PP, PE, ABS, ABS+PC, Nylon, PBT, or PEEK.

14. A method as set forth in claim 11 wherein the filler comprises talc.

15. A method as set forth in claim 11 wherein the wherein the thermoplastic polymer material is a homopolymer, copolymer, or terpolymer.

16. A method as set forth in claim 15 wherein the protrusion comprises at least one of dog house, locator boss, carrot, or clip attachment.

17. A method as set forth in claim 11 wherein component structure has a coefficient of linear expansion of about 5×10⁻⁵ mm/(mm·° C.) or less.

18. A method as set forth in claim 11 wherein the component structure has a melt flow rate of greater than about 12 grams/10 min.

19. A method as set forth in claim 11 wherein the component structure comprises a protrusion wall stock is about 15 to 30% of a component structure wall stock.

20. A method as set forth in claim 11 wherein the filler is at least 12% of the total weight of the component structure.
